(19) United States
(12) Patent Application Publication
(10) Pub. No.: US 2017/0343802 A1
(43) Pub. Date: Nov. 30, 2017

(54) VEHICLE, HEAD-UP DISPLAYING SYSTEM AND PROJECTOR THEREFOR

(71) Applicant: BYD COMPANY LIMITED, Shenzhen, Guangdong (CN)

(72) Inventors: Li LING, Shenzhen (CN); Yifeng WU, Shenzhen (CN); Ming LI, Shenzhen (CN)

(73) Assignee: BYD COMPANY LIMITED, Shenzhen, Guangdong (CN)

(21) Appl. No.: 15/536,049

(22) PCT Filed: Dec. 25, 2015
(86) PCT No.: PCT/CN2015/099017

§ 371 Date: Jun. 14, 2017

(30) Foreign Application Priority Data
Dec. 25, 2014 (CN) 201410820321.6

(51) Int. Cl. G02B 27/01

(52) U.S. Cl. CPC G02B 27/0101; G02B 27/0176; G02B 2027/0141; G02B 2027/0183; G02B 2027/0181

(57) ABSTRACT

A projector for HUD includes a displaying component (1) configured to project an image, and a three-mirror optical device (10) configured to reflect the image onto a front windshield (5) which reflects the image to a driver's eyes. The three-mirror optical device (10) comprises a zoom lens assembly (2) having a zoom lens (21) for zooming in/out the image projected by the displaying component (1), and an image quality compensation lens assembly (3) having an image quality compensation lens (31) for compensating for an image quality distortion caused during a change of the focus of the zoom lens(21), and a front windshield compensation lens assembly (4), configured to compensate for a distortion caused by the front windshield (5). A first and a second focus adjusting component (22, 32) are configured to adjust the focus of the zoom lens (21) and the focus of quality compensation lens (31), respectively.

### CROSS REFERENCE TO RELATED APPLICATION

This application claims priority and benefits of Chinese Patent Application No. 201410820321.6, filed with State Intellectual Property Office, P. R. C. on Dec. 25, 2014, the entire content of which is incorporated herein by reference.

### FIELD

Embodiments of the present disclosure generally relate to a vehicle, and more particularly, to a projector, a head-up displaying system and a vehicle.

### BACKGROUND

With the improvement of the level of living, there are more requirements for the vehicle. Presently, some vehicles are provided with head-up displaying systems. The head-up displaying system is mounted on a dashboard of a vehicle, projects information onto a front windshield in a form of text and image using the optical reflection principle. And a height of the image and eyes of a driver are generally at the same level. The driver may view a virtual image reflected by the front windshield with the image projected by the head-up displaying system. In this way, it is easy for the driver to combine a scene outside and the information displayed by the head-up displaying system during driving. The driver may view navigation information, the speed of the vehicle and other information without bowing his/her head, such that the problem of distracting the attention from the road ahead may be avoided, thus improving the driving security.

Nowadays, in the head-up displaying system, in order to ensure that the image would not obstruct the sightline of the driver, the size of the image viewed by the driver is generally less than 13 inches. Because the image is too small, the information displayed in the projected image is limited, and the diversity and the detail of the information displayed cannot be taken into account, and thus the information displayed in the HUD simultaneously is limited (for example, for the complex information such as map, the HUD cannot display it to the driver clearly and completely).

### SUMMARY

Embodiments of the present disclosure seek to solve at least one of the problems existing in the related art to at least some extent.

According to embodiments of a first aspect of the present disclosure, there is provided a projector for a head-up displaying system. The projector includes: a displaying component configured to project an image, and a three-mirror optical device positioned in an optical path of an emergent light of the displaying component, configured to reflect the image projected by the displaying component onto a front windshield such that the front windshield reflects the image to eyes of a driver, and comprising: a zoom lens assembly having a zoom lens for zooming in/out the image projected by the displaying component, and a first focus adjusting component configured to adjust a focus of the zoom lens; an image quality compensation lens assembly, having an image quality compensation lens configured to compensate for an image quality distortion caused during a change of the focus of the zoom lens, and a second focus adjusting component configured to adjust a focus of the image quality compensation lens; and a front windshield compensation lens assembly, configured to compensate for an image distortion caused by the front windshield.

With the projector according to the present disclosure, the three-mirror optical device is positioned in the optical path of the emergent light of the displaying component. In the three-mirror optical device, the zoom lens assembly includes the zoom lens and the first focus adjusting component, the image quality compensation lens assembly includes a second focus adjusting component, and thus by changing the positions of the first focus adjusting component and the second focus adjusting component, the focus of the optical path of the head-up displaying system can be adjusted, the continuous zoom can be realized, and the conjugate distance is invariant. For the projector, the object distance and the image distance are invariant, only the magnification ratio of the projector is changed, such that the content of the image may be enlarged by several times or even more than ten times, and the position of the image is unchanged. Furthermore, the image quality is stable, the situation that the enlarged image is fuzzy or deformed may be avoided, and abundant information may be provided for the driver in the limited space.

According to embodiments of a second aspect of the present disclosure, there is provided a head-up displaying system. The head-up displaying system includes the projector described above.

With the head-up displaying system according to the present disclosure, the three-mirror optical device is positioned in the optical path of the emergent light of the displaying component. In the three-mirror optical device, the zoom lens assembly includes the zoom lens and the first focus adjusting component, the image quality compensation lens assembly includes a second focus adjusting component, and thus by changing the positions of the first focus adjusting component and the second focus adjusting component, the focus of the optical path of the head-up displaying system can be adjusted, the continuous zoom can be realized, and the conjugate distance is invariant. For the head-up displaying system, the object distance and the image distance are invariant, only the magnification ratio of the head-up displaying system is changed, such that the content of the image may be enlarged by several times or even more than ten times, and the position of the image is unchanged. Furthermore, the image quality is stable, the situation that the enlarged image is fuzzy or deformed may be avoided, and the abundant information may be provided for the driver in the limited space.

According to embodiments of a third aspect of the present disclosure, there is provided a vehicle. The vehicle includes a head-up displaying system described above.

With the vehicle according to the present disclosure, the three-mirror optical device is positioned in the optical path of the emergent light of the displaying component. In the three-mirror optical device, the zoom lens assembly includes the zoom lens and the first focus adjusting component, the image quality compensation lens assembly includes a second focus adjusting component, and thus by changing the positions of the first focus adjusting component and the second focus adjusting component, the focus of the optical path of the head-up displaying system can be adjusted, the continuous zoom can be realized, and the conjugate distance is invariant. For the head-up displaying system, the object distance and the image distance are invariant, only the magnification ratio of the head-up displaying system is changed, such that the content of the image may be enlarged by several times or even more than ten times, and the position of the image is unchanged t. Furthermore, the image quality is stable, the situation that the enlarged image is fuzzy or deformed may be avoided, and abundant information may be provided for the driver in the limited space.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic diagram illustrating an optical path in a head-up displaying system according to an embodiment of the present disclosure;

FIG. 2 is a schematic diagram of a first focus adjusting component or a second focus adjusting component according to an embodiment of the present disclosure; and

FIG. 3 is a schematic diagram of a zoom cam unit or an image quality cam unit according to another embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the following, a projector for a head-up displaying system, a head-up displaying system, and a vehicle are described in detail with reference to drawings.

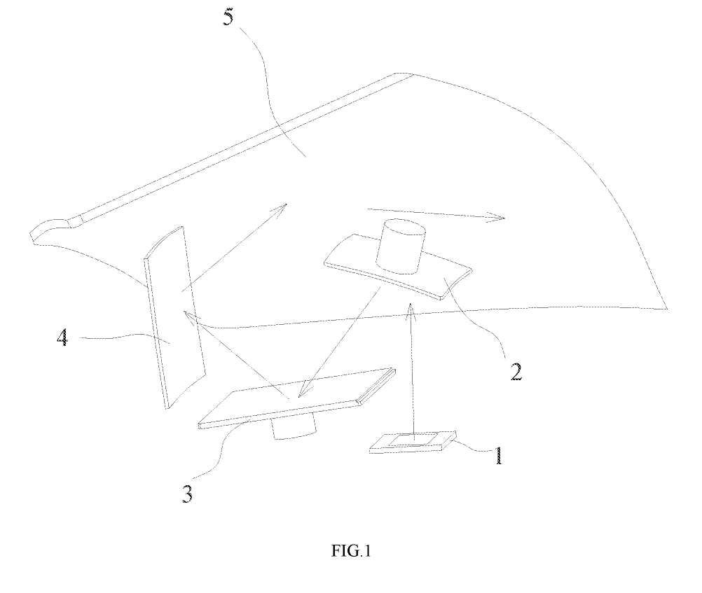

FIG. 1 is a schematic diagram illustrating an optical path in a head-up displaying system according to an embodiment of the present disclosure. As shown in FIG. 1, a projector for a head-up displaying system includes a displaying component 1 and a three-mirror optical device 10. The displaying component 1 is configured to project an image. The three-mirror optical device 10 is positioned in an optical path of an emergent light of the displaying component 1 and is configured to reflect the image projected by the displaying component 1 onto a front windshield 5 such that the front windshield 5 reflects the image to eyes of a driver.

The three-mirror optical device 10 includes: a zoom lens assembly 2, an image quality compensation lens assembly 3, and a front windshield compensation lens assembly 4. The zoom lens assembly 2, the image quality compensation lens assembly 3 and the front windshield compensation lens assembly 4 are sequentially disposed in the optical path of the emergent light.

The zoom lens assembly 2 has a zoom lens 21 for zooming in/out the image projected by the displaying component 1, and a first focus adjusting component 22 for adjusting a focus of the zoom lens 21.

The image quality compensation lens assembly 3 has an image quality compensation lens 31 configured to compensate for an image quality distortion caused during a change of the focus of the zoom lens, and a second focus adjusting component 32 for adjusting a focus of the image quality compensation lens 31. In an embodiment, adjusting focus can also be called zooming, which refers that the focus of the optical device in the optical path is adjusted, i.e., the focus of the optical device is changed.

The front windshield compensation lens assembly 4 is configured to compensate for an image distortion caused by the front windshield 5. At the same time, the front windshield compensation lens assembly 4 is configured to reflect the light from the image quality compensation lens assembly 3 onto the front windshield 5. Furthermore, by adding an angle adjusting mechanism in the front windshield compensation lens assembly 4, the angle of reflection can be adjusted, thus adjusting a height of the image of the projector. After being reflected by the zoom lens assembly 2, the image quality compensation lens assembly 3, the front windshield compensation lens assembly 4 and the front windshield 5, the light sent by the displaying component 1 is reflected to the eyes of the driver.

In an embodiment, the zoom lens assembly 2 can be used to reflect the optical path, and configured to zoom in/out the image projected by the displaying component 1, and the focus of the zoom lens 21 may be adjusted by the first focus adjusting component 22, such that the magnification times of the image may be adjusted. The image may be distorted and the image quality may be lessened after zooming in/out the image by the zoom lens assembly 2. Thus, the image quality compensation lens assembly 3 is disposed behind the zoom lens assembly 2 in the optical path of the emergent light.

The image quality compensation lens assembly 3 may adjust the image quality caused by changing the path by the zoom lens assembly 2, and compensate for the image quality in the case that the object plane is stationary, such that the image quality of the image projected by the head-up displaying system does not reduce greatly during the change of the focus. Also, the focus of the image quality compensation lens 31 may be changed regularly. Since the front windshield 5 of the vehicle is arc glass, a pincushion distortion or barrel distortion may occur on the image projected onto the front windshield 5. For eliminating the distortion, the front windshield compensation lens assembly 4 is disposed in the optical path.

Each of the zoom lens 21 and the image quality compensation lens 31 is a concave mirror. And the front windshield compensation lens assembly 4 is a saddle mirror (named as Biconic, the surface type means that aspheric coefficients can be added in a horizontal direction and a vertical direction).

The displaying component 1 may be any known structure. The displaying component 1 includes a transmission-type displaying screen and an optical source component beneath the transmission-type displaying screen. The optical source generated by the optical source component irradiates the transmission-type displaying screen to project the image displayed on the transmission-type displaying screen. In this embodiment, the optical source component includes a backlight plate, and backlights distributed on the backlight plate in an array mode. As a preferred implementation, the optical source component may also be provided with condensing lenses corresponding respectively to the backlights and distributed in the array mode. The condensing lenses may be disposed on the backlight plate directly, or the condensing lenses may cover the backlights. The condensing lenses may also be stuck on a condensing substrate, or integrated with the condensing substrate. The condensing lenses may condense light, improve the utilization of the light, enable the emergent light to be even, and achieve a better irradiation effect.

“a zoom lens assembly 2, an image quality compensation lens assembly 3, and a front windshield compensation lens assembly 4 sequentially disposed in the optical path of the emergent light” means that, the zoom lens assembly 2 is disposed in the optical path of the emergent light of the displaying component 1, the image quality compensation lens assembly 3 is disposed in the optical path of the emergent light of the zoom lens assembly 2, the front windshield compensation lens assembly 4 is disposed in the optical path of the emergent light of the image quality compensation lens assembly 3, and the emergent light of the front windshield compensation lens assembly 4 is projected onto the front windshield 5.

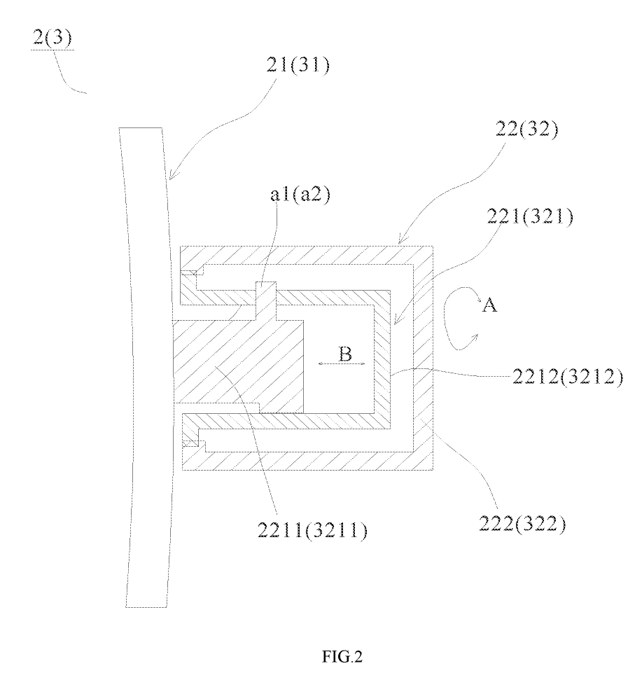

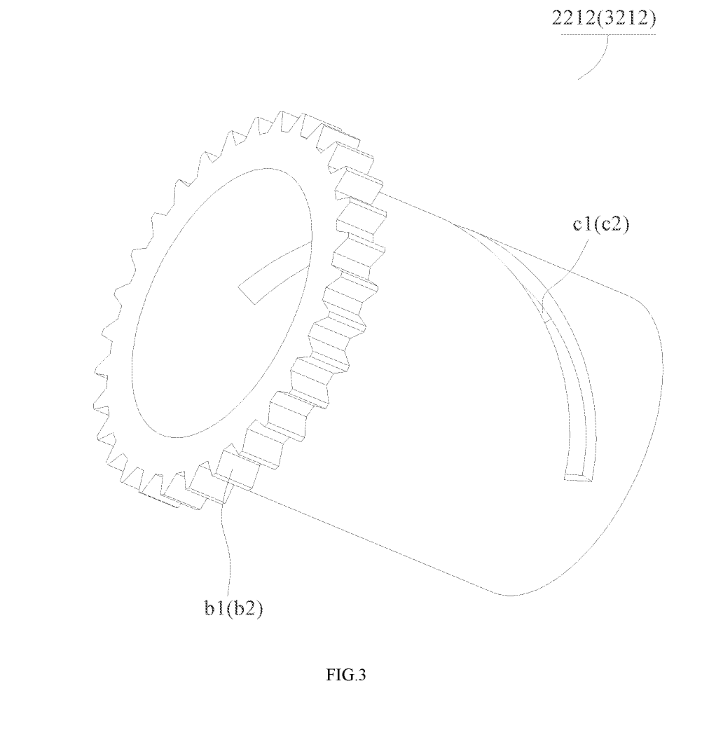

FIG. 2 is a schematic diagram of a first focus adjusting component or a second focus adjusting component according to an embodiment of the present disclosure. FIG. 3 is a schematic diagram of a zoom cam unit or an image quality cam unit according to another embodiment of the present disclosure. In an embodiment, as shown in FIG. 2 and FIG. 3, a moving path of the zoom lens 21 is similar to that of the image quality compensation lens 31, the difference between the zoom lens 21 and the image quality compensation lens 31 is in that a shape of the zoom curve groove c1 is different from that of the image quality curve groove c2. Therefore, a prefix such as “zoom” or “zoom lens” is added to the “rotating motor”, the “cam unit”, the “cam”, and the “fixing shaft” of the first focus adjusting component 22, and a prefix such as “image quality” or “image quality lens” is added to the “rotating motor”, the “cam unit”, the “cam”, and the “fixing shaft” of the second focus adjusting component 32, thus the first focus adjusting component 22 and the second focus adjusting component 32 may be distinguished. In an embodiment, the shape of the cam is not limited, and the cam may be an object capable of converting a rotary motion into a linear motion, which can be named as the cam based on the working principle, however, other name is available for this object. As long as the function of the object is to convert the rotary motion into the linear motion, and to drive the linear motion of the zoom lens 21 and the image quality compensation lens 31.

In an embodiment, the first focus adjusting component 22 includes a zoom rotating motor 222 and a zoom cam unit 221. The zoom cam unit 221 includes a hollow cylindrical zoom cam 2212 having a zoom curve groove c1 formed in a side surface thereof, and a zoom lens fixing shaft 2211 disposed in the hollow cylindrical zoom cam 2212 and fixed on a back surface of the zoom lens 21 and having a zoom slide pin a1 configured to insert into the zoom curve groove.

The zoom rotating motor 222 is engaged with the zoom cam 2212 to rotate the zoom cam 2212, so as to drive the zoom slide pin a1 to slide in the zoom curve groove c1.

As shown in FIG. 2, when being driven by the zoom rotating motor 222, the zoom cam 2212 rotates along the direction indicated by the arrow A counterclockwise or clockwise, the zoom slide pin a1 is sliding in the zoom curve groove c1 to drive the zoom lens fixing shaft 2211 to move to front or back along the direction indicated by the arrow B, so as to drive the zoom lens 21 to move to front or back in the optical path (as shown in FIG. 2, move to left or right).

In an embodiment, the zoom rotating motor 222 has a first output shaft provided with a first gear. The zoom cam 2212 has a second gear b1 meshed with the first gear of the first output shaft.

In an embodiment, the zoom rotating motor 222 has a first output shaft provided with a first gear. The zoom cam 2212 has a second gear, and a first gear train disposed between the first gear and the second gear, and the first gear train is meshed with the first gear and the second gear respectively so as to transmit a rotation of the first output shaft to the zoom cam 2212.

In an embodiment, the zoom lens 21 is disposed in a zoom lens frame. The zoom lens fixing shaft 2211 is fixed on a back surface of the zoom lens frame via a screw, or a pin or is integral with the zoom lens frame, such that there is no movement of the zoom lens 21 relative to the zoom lens fixing shaft 3211.

In an embodiment, as shown in FIG. 2 and FIG. 3, the second focus adjusting component 32 includes: an image quality rotating motor 322 and an image quality cam unit 321. The image quality cam unit 321 includes a hollow cylindrical image quality cam 3212 having an image quality curve groove c2 formed in a side surface, and an image quality compensation lens fixing shaft 3211 disposed in the image quality cam 3212 and fixed on a back surface of the image quality compensation lens 31 and provided with an image quality slide pin a2 configured to insert into the image quality curve groove c2.

The image quality rotating motor 322 is engaged with the image quality cam 3212 to rotate the image quality cam 3212, so as to drive the image quality slide pin a2 to slide in the image quality curve groove c2.

As shown in FIG. 2, when being driven by the image quality rotating motor 322, the image quality cam 3212 rotates along the direction indicated by the arrow A counterclockwise or clockwise, the image quality slide pin a2 is sliding in the image quality curve groove c2 to drive the image quality lens fixing shaft 3211 to move to front or back along the direction indicated by the arrow B, so as to drive the image quality lens 31 to move to front or back in the optical path (as shown in FIG. 2, move to left or right).

In an embodiment, the image quality rotating motor 322 has a second output shaft provided with a third gear. The image quality cam 3212 has a fourth gear b1 meshed with the third gear of the second output shaft. The image quality cam 3212 has a fourth gear, and a second gear train disposed between the third gear and the fourth gear, and the second gear train is meshed with the third gear and the fourth gear respectively so as to transmit a rotation of the second output shaft to the image quality cam 3212.

In an embodiment, the image quality lens 31 is disposed in an image quality compensation lens frame. The image quality compensation lens fixing shaft 3211 is fixed on a back surface of the image quality compensation lens frame via a screw thread, or a pin or is integral with the image quality compensation lens frame such that there is no movement of the image quality lens 31 relative to the image quality lens fixing shaft 3211.

With the projector according to the present disclosure, the three-mirror optical device is positioned in the optical path of the emergent light of the displaying component. In the three-mirror optical device, the zoom lens assembly includes the zoom lens and the first focus adjusting component, the image quality compensation lens assembly includes a second focus adjusting component, and thus by changing the positions of the first focus adjusting component and the second focus adjusting component, the focus of the optical path of the head-up displaying system can be adjusted, the continuous zoom can be realized, and the conjugate distance is invariant. For the projector, the object distance and the image distance are invariant, only the magnification ratio of the projector is changed, such that the content of the image may be enlarged by several times or even more than ten times, and the position of the image is unchanged. Furthermore, the image quality is stable, the situation that the enlarged image is fuzzy or deformed may be avoided, and abundant information may be provided for the driver in the limited space.

In an embodiment, the head-up displaying system includes the above projector.

The adjusting focus principle of the projector is described as follow.

The system focus f′ of the projector can be calculated according the following formula.

f′=f′₁a₂a₃ (1)

Where, f′₁ is the focus of the front windshield compensation lens, and a₂, a₃ are the magnification ratios of the zoom lens 21 and the image quality compensation lens 31 respectively.

The zoom rate Γ during the zooming process of the head-up displaying system can be calculated according the following formula.

$$Γ = \frac{{a}_{20} {a}_{30}}{{a}_{21} {a}_{31}} \qquad ( 2 )$$

Where, a₂₀ is the magnification ratio of the zoom lens 21 before zooming; a₃₀ is the magnification ratio of the image quality compensation lens 31 before zooming∘ a₂₁ is the magnification ratio of the zoom lens 21 after zooming; a₃₁ is the magnification ratio of the image quality compensation lens 31 after zooming.

In the adjusting focus process, in order to keep the stability of the image plane, it is ensured that the sum of the conjugate distances of the zoom lens 21 and the image quality compensation lens 31 is constant during the zooming process. The formula is as follow.

D₂₀+D₃₀=D₂₁+D₃₁ (3)

Where, D₂₀ is the conjugate distance of the zoom lens 21 before zooming; D₃₀ is the conjugate distance of the image quality compensation lens 31 before zooming∘ D₂₁ is the conjugate distance of the zoom lens 21 after zooming; D₃₁ is the conjugate distance of the image quality compensation lens 31 after zooming.

In the ideal optical system, the position relationship between the image and the object of the spherical mirror is as follow.

$$\frac{1}{{l}^{′}} + \frac{1}{l} = \frac{2}{r} \qquad ( 4 )$$

Where, l′ is the image distance of the spherical mirror, 1 is the object distance of the spherical mirror, and r is the curvature radius of the spherical mirror.

The magnification ratio a can be calculated by the following formula.

$$a = - \frac{{l}^{′}}{l} \qquad ( 5 )$$

The conjugate distance of the i^{th} spherical mirror can be calculated by the following formula.

$${D}_{i} = {l}_{i}^{′} - {l}_{i} = ( \frac{1}{{a}_{i}} - {a}_{i} ) \frac{{r}_{i}}{2} \qquad ( 6 )$$

In the formula (6), rᵢ is the curvature radius of the i^{th} spherical mirror.

The formula (6) is substituted into the formula (3) to obtain the following formula.

$$( \frac{1}{{a}_{20}} - {a}_{20} - \frac{1}{{a}_{21}} + {a}_{20} ) \frac{{r}_{2}}{2} = ( \frac{1}{{a}_{30}} - {a}_{30} - \frac{1}{{a}_{31}} + {a}_{30} ) \frac{{r}_{3}}{2} \qquad ( 7 )$$

In the formula (7), r₂ and r₃ are the curvature radiuses of the zoom lens 21 and the image quality lens 31 respectively.

When a₂₀, a₂₁, and a₃₀ are known, the formula (7) is transformed to obtain the following formula.

a₃₁²−ca₃₁−1=0 (8)

The parameter c in the formula (8) can be obtained, and be expressed by the following formula.

$$c = - \frac{{r}_{2}}{{r}_{3}} ( {a}_{21} - \frac{1}{{a}_{21}} - {a}_{20} + \frac{1}{{a}_{20}} ) + ( {a}_{30} - \frac{1}{{a}_{30}} ) \qquad ( 9 )$$

The formula (8) has two solutions, and the result is the following formula (10).

$${a}_{31} = \frac{c \pm \sqrt{{c}^{2} + 4}}{2} \qquad ( 10 )$$

Find the derivations of the magnification ratio of the image quality lens 31 after zooming a₃₁ and the magnification ratio of the zoom lens 21 after zooming a₂₁ respectively to obtain the following formula (11)

$$\frac{{da}_{ 31}}{{da}_{ 21}} = - \frac{1 + \frac{1}{{a}_{21}^{2}}}{1 + \frac{1}{{a}_{31}^{2}}} \cdot \frac{{r}_{2}}{{r}_{3}} \neq 0 \qquad ( 11 )$$

The result can be obtained according to the following formula (11) that a₃₁ is changed monotonously with a₂₁, and one of the solutions of a₃₁ may be abandoned according to the actual situation.

According to the Gauss optics theory, an offset z₁ of the zoom lens 21 relative to the initial position can be obtained according to the following formula.

$${z}_{1} = - {dl}_{2} = {f}_{2}^{′} ( \frac{1}{{a}_{20}} - \frac{1}{{a}_{21}} ) \qquad ( 12 )$$

An offset z₂ of the image quality compensation lens 31 relative to the initial position corresponding to can be obtained according to the following formula.

z₂=dl′₃=f′₃=f′₃(a₃₁−a₃₀) (13)

The curve of the zoom curve groove c1 of the zoom cam 2212 and the curve of the image quality curve groove c2 of the image quality cam 3212 can be obtain according to the formula (12) and the formula (13).

The zoom curve groove c1 of the zoom cam 2212 and the image quality curve groove c2 of the image quality cam 3212 can be obtained according to the curve of the zoom curve groove c1 of the zoom cam 2212 and the curve of the image quality curve groove c2 of the image quality cam 3212, and then the zoom cam 2212 and the image quality cam 3212 can be obtained according to the zoom curve groove c1 and the image quality curve groove c2. The zoom rotating motor 222 controlling the zoom cam 2212 is synchronous with the image quality rotating motor 322 controlling and the image quality cam 3212 to rotate, and then, by the cooperation between the zoom curve groove c1 and the zoom slide pin a1, and the cooperation between the image quality curve groove c2 and the image quality slide pin a2, the linear motion of the zoom lens 21 and the linear motion of the image quality lens 31 can be realized, and the continuous zoom can be realized.

The same plus signal is provided to the zoom rotating motor 222 and the image quality rotating motor 322 synchronously, and the signals to the zoom rotating motor 222 and the image quality rotating motor 322 are synchronous, and thus the zoom lens 21 and the image quality lens 31 change their positions at the same time, the image position is unchanged, and the image quality is stable.

The working principle of the head-up displaying system is described as follow.

The zoom lens assembly 2 and the image quality compensation lens assembly 3 can adjust respective focus automatically, and the conjugate distances of the zoom lens assembly 2 and the image quality compensation lens assembly 3 are invariant. For the head-up displaying system, the object distance and the image distance are invariant, only the magnification ratio of the head-up displaying system is changed, which can enlarge or narrow the content of the image. The image quality can be adjusted automatically. The front windshield compensation lens assembly 4 can compensate for the distortion caused by the front windshield 5 to prevent the image distortion.

With the head-up displaying system according to the present disclosure, the three-mirror optical device is positioned in the optical path of the emergent light of the displaying component. In the three-mirror optical device, the zoom lens assembly includes the zoom lens and the first focus adjusting component, the image quality compensation lens assembly includes a second focus adjusting component, and thus by changing the positions of the first focus adjusting component and the second focus adjusting component, the focus of the optical path of the head-up displaying system can be adjusted, the continuous zoom can be realized, and the conjugate distance is invariant. For the head-up displaying system, the object distance and the image distance are invariant, only the magnification ratio of the head-up displaying system is changed, such that the content of the image may be enlarged by several times or even more than ten times, and the position of the image is unchanged. Furthermore, the image quality is stable, the situation that the enlarged image is fuzzy or deformed may be avoided, and the abundant information may be provided for the driver in the limited space.

In an embodiment, the vehicle includes the above head-up displaying system.

With the vehicle according to the present disclosure, the three-mirror optical device is positioned in the optical path of the emergent light of the displaying component. In the three-mirror optical device, the zoom lens assembly includes the zoom lens and the first focus adjusting component, the image quality compensation lens assembly includes a second focus adjusting component, and thus by changing the positions of the first focus adjusting component and the second focus adjusting component, the focus of the optical path of the head-up displaying system can be adjusted, the continuous zoom can be realized, and the conjugate distance is invariant. For the head-up displaying system, the object distance and the image distance are invariant, only the magnification ratio of the head-up displaying system is changed, such that the content of the image may be enlarged by several times or even more than ten times, and the position of the image is unchanged. Furthermore, the image quality is stable, the situation that the enlarged image is fuzzy or deformed may be avoided, and abundant information may be provided for the driver in the limited space.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A projector for a head-up displaying system, comprising:
a displaying component configured to project an image, and
a three-mirror optical device positioned in an optical path of an emergent light of the displaying component, configured to reflect the image projected by the displaying component onto a front windshield such that the front windshield reflects the image to eyes of a driver, and comprising:
a zoom lens assembly, comprising a zoom lens for zooming in/out the image projected by the displaying component, and a first focus adjusting component configured to adjust a focus of the zoom lens;
an image quality compensation lens assembly, comprising an image quality compensation lens configured to compensate for an image quality distortion caused during a change of the focus of the zoom lens, and a second focus adjusting component configured to adjust a focus of the image quality compensation lens; and
a front windshield compensation lens assembly, configured to compensate for an image distortion caused by the front windshield.

2. The projector according to claim 1, wherein the zoom lens assembly, the image quality compensation lens assembly and the front windshield compensation lens assembly are sequentially disposed in the optical path of the emergent light of the displaying component.

3. The projector according to claim 1, wherein the first focus adjusting component comprises:
a zoom rotating motor, and
a zoom cam unit, comprising:
a hollow cylindrical zoom cam having a zoom curve groove formed in a side surface thereof, and
a zoom lens fixing shaft, disposed in the zoom cam, fixed on a back surface of the zoom lens, and having a zoom slide pin configured to insert into the zoom curve groove;
wherein the zoom rotating motor is engaged with the zoom cam to rotate the zoom cam, so as to drive the zoom slide pin to slide in the zoom curve groove.

4. The projector according to claim 3, wherein the zoom rotating motor has a first output shaft provided with a first gear;
wherein the zoom cam has a second gear meshed with the first gear.

5. The projector according to claim 3, wherein the zoom rotating motor has a first output shaft provided with a first gear;
wherein the zoom cam comprises a second gear and a first gear train disposed between the first gear and the second gear;
wherein the first gear train is meshed with the first gear and the second gear respectively so as to transmit a rotation of the first output shaft to the zoom cam.

6. The projector according to claim 3, wherein the zoom lens is disposed in a zoom lens frame.

7. The projector according to claim 6, wherein the zoom lens fixing shaft is fixed on a back surface of the zoom lens frame via a screw or a pin, or is integral with the zoom lens frame.

8. The projector according to claim 3, wherein the second focus adjusting component comprises:
an image quality rotating motor, and
an image quality cam unit comprising:
a hollow cylindrical image quality cam, having an image quality curve groove formed in a side surface, and
an image quality compensation lens fixing shaft, disposed in the image quality cam, fixed on a back surface of the image quality compensation lens, and provided with an image quality slide pin configured to insert into the image quality curve groove; and
wherein the image quality rotating motor is engaged with the image quality cam to rotate the image quality cam, so as to drive the image quality slide pin to slide in the image quality curve groove.

9. The projector according to claim 8, wherein the image quality rotating motor has a second output shaft provided with a third gear;
wherein the image quality cam has a fourth gear meshed with the third gear.

10. The projector according to claim 8, wherein the image quality rotating motor has a second output shaft provided with a third gear;
wherein the image quality cam comprises a fourth gear and a second gear train disposed between the third gear and the fourth gear;
wherein the second gear train is meshed with the third gear and the fourth gear respectively so as to transmit a rotation of the second output shaft to the image quality cam.

11. The projector according to claim 8, wherein the image quality compensation lens is disposed in an image quality compensation lens frame.

12. The projector according to claim 11, wherein the image quality compensation lens fixing shaft is fixed on the back surface of the image quality compensation lens frame via a screw or a pin, or is integral with the image quality compensation lens frame.

13. A head-up displaying system, comprising a projector for a head-up displaying system, comprising:
a displaying component configured to project an image, and
a three-mirror optical device positioned in an optical path of an emergent light of the displaying component, configured to reflect the image projected by the displaying component onto a front windshield such that the front windshield reflects the image to eyes of a driver, and comprising:
a zoom lens assembly, comprising a zoom lens for zooming in/out the image projected by the displaying component, and a first focus adjusting component configured to adjust a focus of the zoom lens;
an image quality compensation lens assembly, comprising an image quality compensation lens configured to compensate for an image quality distortion caused during a change of the focus of the zoom lens, and a second focus adjusting component configured to adjust a focus of the image quality compensation lens; and
a front windshield compensation lens assembly, configured to compensate for an image distortion caused by the front windshield.

14. A vehicle, comprising a head-up displaying system, comprising a projector for a head-up displaying system, comprising:
a displaying component configured to project an image, and
a three-mirror optical device positioned in an optical path of an emergent light of the displaying component, configured to reflect the image projected by the displaying component onto a front windshield such that the front windshield reflects the image to eyes of a driver, and comprising:
a zoom lens assembly, comprising a zoom lens for zooming in/out the image projected by the displaying component, and a first focus adjusting component configured to adjust a focus of the zoom lens;
an image quality compensation lens assembly, comprising an image quality compensation lens configured to compensate for an image quality distortion caused during a change of the focus of the zoom lens, and a second focus adjusting component configured to adjust a focus of the image quality compensation lens; and
a front windshield compensation lens assembly, configured to compensate for an image distortion caused by the front windshield.
